(19) United States
(12) Patent Application Publication
(10) Pub. No.: US 2017/0318830 A1
(43) Pub. Date: Nov. 9, 2017

(54) Apparatus and method for producing frozen, comestible products entrained with a gas

(71) Applicants: Jeffrey D. Resnick, Superior, CO (US); Kevin Resnick, Erie, CO (US)

(72) Inventors: Jeffrey D. Resnick, Superior, CO (US); Kevin Resnick, Erie, CO (US)

(21) Appl. No.: 15/586,126

(22) Filed: May 3, 2017

Related U.S. Application Data
(60) Provisional application No. 62/331,895, filed on May 4, 2016.

(51) Int. Cl. A23G 9/20; A23G 9/28; A23G 9/22

(52) U.S. Cl. CPC A23G 9/20; A23G 9/222; A23G 9/28

(57) ABSTRACT

Disclosed herein are methods, systems, and apparatuses for producing frozen comestible products with entrained gas. The systems and apparatuses may function for long periods of time without cleaning. The systems and apparatuses may be used in producing soft-serve products entrained with a gas including soft-serve ice cream, soft-serve frozen yogurt, frozen pureed fruit, sorbet, soft-serve frozen custard, and other foods capable of being made into soft-serve products. An overrun control module, which may include a gas regulator or a pressure switch, may regulate quantities of a freezable comestible mixture and a compressed gas that pass through to an accumulator, where the gas becomes entrained in (e.g., dissolves in or becomes suspended in) the freezable comestible mixture. The freezable comestible mixture entrained with a gas may pass to the freezing chamber, which produces a frozen comestible product entrained with a gas. The system may be maintained at a state of overpressurization to reduce or eliminate environmental air and environmental contaminants from entering the system, which may increase the amount of time between cleanings.

### TECHNICAL FIELD

Described herein are methods and systems for hygienically dispensing frozen, comestible products having entrained gases, including sweet, dairy-based products.

### BACKGROUND

The information included in this Background section of the specification, including any references cited herein and any description or discussion thereof, is included for technical reference purposes only and is not to be regarded subject matter by which the scope of the invention as defined in the claims is to be bound.

Conventional frozen carbonated beverage systems, including systems that produce ICEE® beverages or SLURPEE® beverages, produce beverages with a Brix value between about 12-15° Bx. Likewise, such beverages generally have a large overrun of between about 80%-140% or more and may be served at temperatures around 25° F.-29° F. These beverages may originate from a syrup (similar to a soda syrup) that is mixed with water and carbonated. The ratios of syrup to water may range between about 3.8:1 to about 4.4:1. The Brix values of these products, along with the amount of dilution that these products undergo before freezing, results in a relatively low-viscosity product that moves easily through the machine.

Soft-serve ice cream, along with related products such as frozen yogurt, frozen custard, frozen pureed fruit, and other related food products capable of being made into a soft serve product, may begin as a highly viscous liquid mixture or as a powder that may be dissolved into water to create a highly viscous liquid mixture. While some dilution may occur, it is often at a much smaller scale than with the ICEE®-type beverages or SLURPEE®-type beverages. Accordingly, the liquid mixture that becomes soft serve ice cream remains relatively more viscous than existing carbonated beverages, and it may become even more viscous during the freezing process. The higher viscosity may result from one or more of less water content, higher Brix values (i.e., higher concentrations of sugar), and differences in components making up the mixture (which may include dairy or dairy substitutes, sugar, egg, flavoring, stabilizers, fillers, starch, among other possibilities—all of which increase the viscosity of the mix—as opposed to just flavored syrup and water). Currently available frozen carbonated beverage machines cannot produce soft-serve-type products.

Differences in starting materials have made it a challenge to entrain products such as soft-serve ice cream, frozen yogurt, frozen custard, and like products with gas(es). Moreover, while conventional soft-serve machines may introduce air from the environment (e.g., by a low-power peristaltic pump), using environmental air may introduce contaminants that, over time, can spoil the soft-serve product and require emptying and cleaning the machine. A machine capable of providing a soft-serve product without requiring frequent cleaning is currently unavailable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

As used herein, a gas being “entrained” in a frozen comestible product or a freezable liquid mixture refers to at least some portion of the gas being suspended or dissolved within the product or mixture, or a combination of the two, depending on the context. Additionally, a “frozen” product, as used herein, may refer to a product that is completely or partially in the solid state of matter as a result of a decrease in temperature. As used herein, a “frozen” product may be predominantly solid but may be partially (e.g., have components in) liquid or gas states. As one skilled in the art will appreciate, temperature and pressure may affect the solidness of a frozen product. As used herein, “overrun” refers to the increased volume of a frozen, comestible product entrained with a gas as compared to the volume of the input freezable, comestible liquid mixture. Overrun may be stated as a percentage, where a 100% overrun refers to a product volume twice that of the input liquid mixture volume. As used herein, Brix (° Bx or degrees Brix) refers to the approximate sugar content of a solution and is generally defined as 1° Bx=1 g. of sucrose in 100 g. of total aqueous solution, where the solution includes both solute and solvent. Brix is a mass fraction and may be used to approximate the dissolved solid (usually sweet solid) content in solution even if the solid is something other than sucrose. As used herein and unless stated otherwise, references to a product's Brix value refers to the Brix value of the product after any dilution, if required, takes place.

The present disclosure is generally related to an apparatus and method for forming a frozen, comestible product entrained with a gas. In some particular embodiments, the comestible, frozen product may be dairy or non-dairy soft-serve ice cream or frozen yogurt, shake, smoothie, or frozen edible product having one or more gases entrained therein.

An apparatus embodying the present disclosure may have a conduit for introducing a freezable liquid mixture into the freezing chamber of the apparatus, as well as a conduit for introducing a compressed gas from a compressed gas source, such as a compressed gas canister. The freezable liquid mixture may be drawn into the conduit from a sealed reservoir for storing the freezable liquid mixture by a pump. An overrun control module may selectively control the ratio of freezable liquid mixture to compressed gas. In general, the overrun control module may aid in controlling the overrun percentage of the entrained liquid mixture and may provide an area in which the gas is initially entrained in the freezable liquid mixture, although entrainment may occur in other areas as well. An accumulator may be provided in fluid communication with the overrun control module and the freezing chamber and may ensure a more homogeneous entrainment of the gas within the freezable liquid mixture and/or frozen product. The accumulator may also help to maintain pressure on the freezing chamber to help ensure proper and consistent dispensing of the frozen product. The accumulator may include or be coupled to a pressure switch or a regulator, which may be activated if the pressure in the apparatus and/or its components falls below a certain level. The pressure switch may cause one or more solenoid valves, e.g., solenoid valves coupled to the compressed gas and/or freezable liquid mixture conduits, to open and replenish the supply of freezable liquid mixture and/or compressed gas until the pressure returns to a certain level. Accordingly, a relatively consistent overpressurization may be maintained. Maintaining the machine at a constant state of overpressurization may prevent or significantly reduce the amount of environmental air entering the system as compared to a conventional soft-serve machine, which may significantly extend the amount of time before the machine needs to be cleaned.

The freezing chamber may have an agitator provided therein for mixing the entrained liquid mixture within the freezing chamber. The agitator may be driven by a motor, the motor may be selected to drive the agitator within a viscous, entrained liquid mixture. Compared to a conventional frozen carbonated beverage machine, the motor envisioned herein may be relatively larger (e.g., in wattage or horsepower) for a comparable volume freezing cylinder due to the higher viscosity of the product. Additionally, the agitator envisioned in the present disclosure may be relatively more robust (e.g., in material, thickness, and the like) compared to a conventional frozen carbonated beverage machine. A cooling assembly, which may include a compressor, Peltier heat pump, or the like, is configured to freeze the entrained liquid mixture within the freezing chamber. Compared to a conventional frozen carbonated beverage machine, the cooling assembly may be capable of reaching colder temperatures (e.g., less than 24 degrees Fahrenheit). A cooling assembly may chill the walls of the freezing chamber, and the agitator may remove frozen or partially frozen product from the walls of the freezing chamber. Alternatively or additionally, a cooling assembly may include refrigerant circulating within the agitator itself. A dispensing assembly may be in communication with the freezing chamber to dispense the comestible frozen product.

The disclosed apparatus, methods, and systems may be able to dispense a frozen, comestible product entrained with a gas that differs from currently available products. For example, soft-serve ice cream or frozen yogurt may become entrained with a gas using the apparatus, systems, and methods disclosed therein. In essence, the frozen, comestible product envisioned by the present disclosure may have different physical properties than conventional products such as slushes. For example, the present disclosure envisions that soft-serve ice creams and frozen yogurts entrained with a gas may have significantly higher viscosities than conventional products, such that the dispensed product is capable of maintaining a shape formed during the dispensing process rather than taking the shape of the container. The frozen, comestible product envisioned herein is meant to be eaten (e.g., from a bowl with a spoon or a cone with the mouth and tongue) rather than drunk (e.g., through a straw) like a conventional product. The products envisioned herein may have higher Brix (20+° Bx compared to 12-15° Bx for conventional frozen carbonated beverage products after any required dilution has taken place), a lower overrun (30-70% compared to 80-140% for conventional frozen carbonated beverage products), or a lower serving temperature (24° F. or less compared to 25-29° F. for conventional frozen carbonated beverage products). The apparatus and systems disclosed herein, to handle the higher viscosity requirements of the freezable mixture and frozen comestible products compared to conventional products, may require larger motors, larger compressors, and heat evaporators and refrigerants that operate at lower temperatures.

The disclosed apparatus, methods, and systems may be able to dispense comestible product for long periods of time without the need to clean and/or disinfect the system. The extended cleaning cycle may be possible because the disclosed system may be sealed-off from ambient air, particularly where the principal components are aseptic and are added to the system aseptically. The disclosed system may also maintain the mixture, products, and components at a positive pressure relative to the ambient atmosphere. This may help to ensure that ambient air or other potential contaminants are not introduced into the system. In many cases, the system can be safely operated for ten days without cleaning. Frequently, an embodiment of systems described herein may be safely operated for several months without cleaning. In particular embodiments, the system may be safely operated for about 90 to about 120 days without cleaning. In other embodiments, the system may even be safely operated for six months without cleaning.

### BRIEF DESCRIPTION OF THE DRAWINGS

The foregoing and other features of the present disclosure will become more fully apparent from the following description, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

In the drawings:

FIG. 1 is a schematic representation of one embodiment of the disclosed system;

FIG. 2 is a schematic representation of one embodiment of a reservoir for use with the disclosed system;

FIG. 3 is a schematic representation of one embodiment of a gas canister for use with the disclosed system; and

FIG. 4 is a schematic representation of an alternate embodiment of the disclosed system.

### DETAILED DESCRIPTION

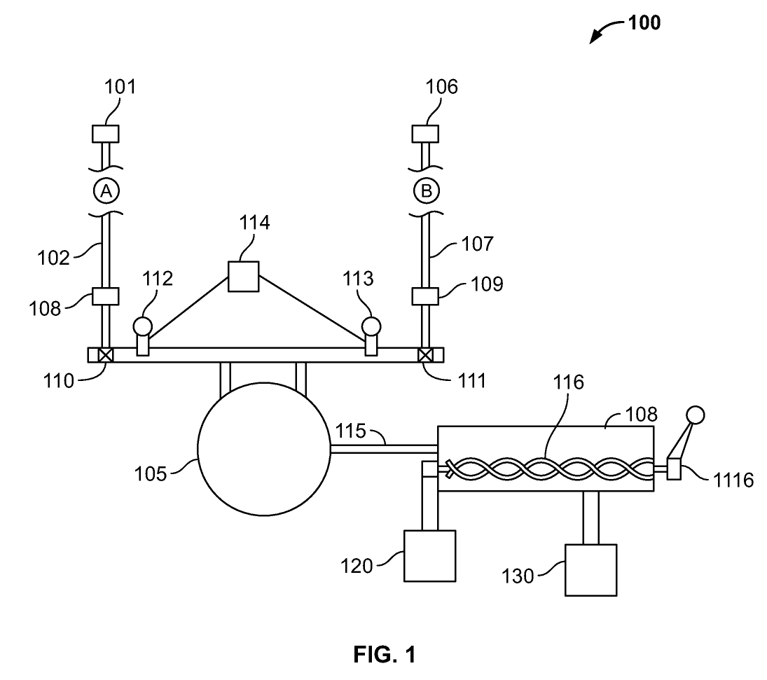

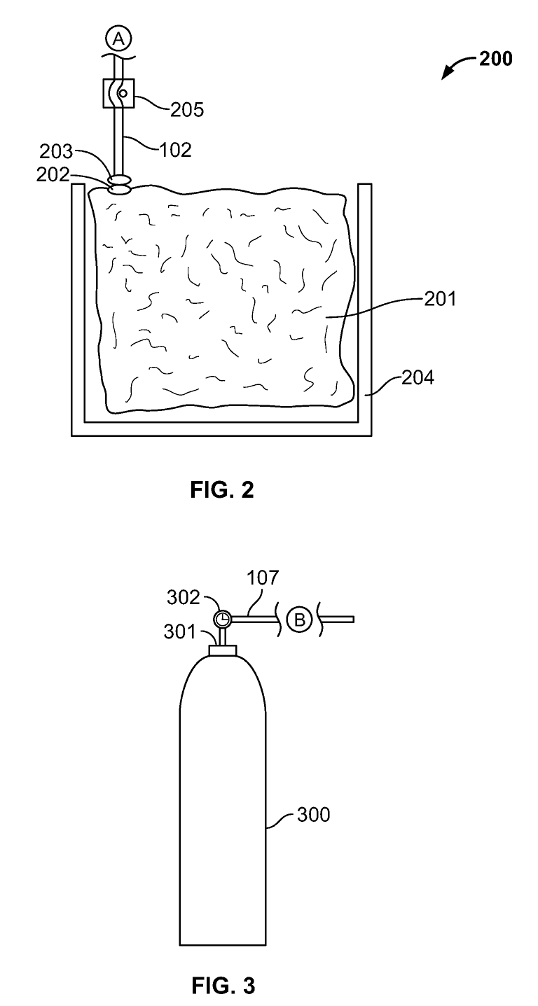

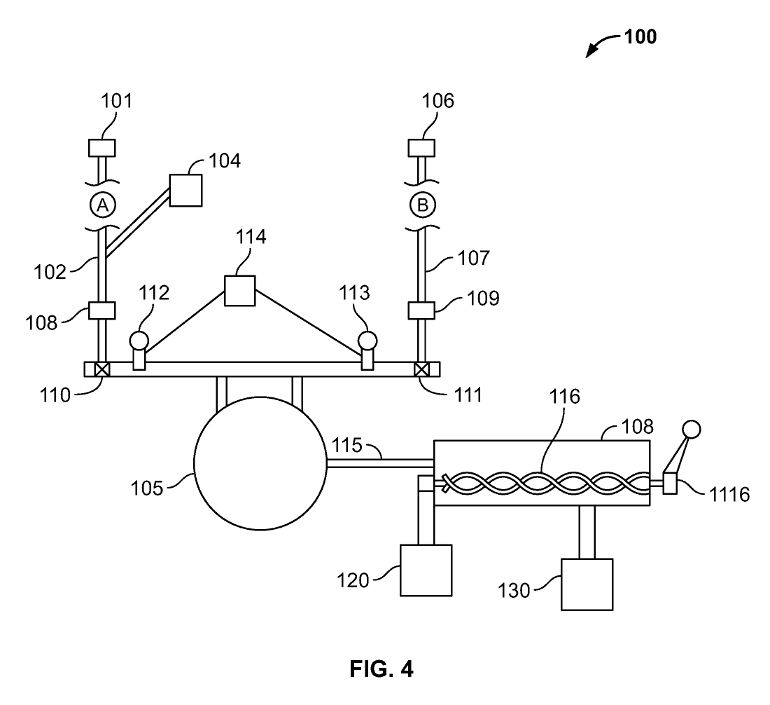

With reference to FIGS. 1-3, the primary components of exemplary embodiments of an apparatus 100 for producing a frozen, comestible product having an entrained gas is shown. Beginning with FIG. 1, a freezable, comestible liquid mixture in reservoir 101 may be coupled with an overrun control module 103 via a product conduit 102, which may also be a first conduit 102. In some examples, the freezable, comestible liquid mixture may be a soft serve ice cream mixture or frozen yogurt liquid mixture. The freezable, comestible liquid mixture may be in concentrated form and diluted with water from a water input 104 or may be present ready-to-use in reservoir 101. Water input 104 may be coupled to product conduit 102 or overrun control module 103. For example, FIG. 4 provides an embodiment of the system of the present disclosure that includes a water input 104 coupled to product conduit 102. In this scenario, water from water input 104 may dilute the freezable, comestible liquid mixture in a controlled fashion, and water input 104 may include a solenoid valve to accomplish this dilution. With reference to FIGS. 1 and 4, product conduit 102 may extend from a first end coupled to reservoir 101, an example of which is described more fully with reference to FIG. 2, to a second end coupled to a freeze chamber 108. Various components may also be positioned along, or as part of, product conduit 102. Overrun control module 103, accumulator 105, and a compressed gas input 106 may be provided before freeze chamber 108. A gas conduit 107, which may be a second conduit 107, may be provided to couple a compressed gas input 106, which may include a compressed gas canister as described in FIG. 3. Gas conduit 107 may extent from a first end (at a connection with a compressed gas canister) to overrun control module 103 at a second end. Overrun control module 103 may adjust the ratio or percentage of gas to volume of liquid. In an embodiment, overrun control module 103 may include or be operatively coupled to a gas regulator or a pressure switch. Overrun control module 103 may be able to withstand and maintain certain pressures in the system, for example, pressures above 25 PSI, pressures above 35 PSI, pressures above 45 PSI, and/or in some cases pressures between about 55 PSI to 120 PSI. Accordingly, a relatively consistent overpressurization using a sterile gas may be maintained. Maintaining the machine at a constant state of overpressurization may prevent or significantly reduce the amount of environmental air (and therefore environmental contaminants) entering the system as compared to a conventional soft-serve machine, which may significantly extend the amount of time between cleanings, which may save product, reduce labor, and reduce machine down-time. Maintaining the machine at a consistent pressurization may also ensure that a more consistent product is dispensed; i.e., variability in the overrun of the product may be reduced.

With brief reference to FIG. 2, a freezable, comestible liquid mixture may be provided within a reservoir system 200. Reservoir system may include a reservoir 201, a male end of a hermetic coupling mechanism 202, a female end of a hermetic coupling mechanism 203, and a reservoir container 204. Reservoir 201 may be hermetically sealed before coupling with product conduit 102 and may prevent the liquid mixture from becoming contaminated and/or spoiling when stored or transported over an extended period of time. For instance, in some examples the shelf life of the liquid mixture when stored in the reservoir 201 may be several months, a year, or more. The reservoir 201 may be a flexible bag or may be a rigid structure. In one example, the reservoir 201 may be a flexible plastic bag. Reservoir 201 may be a bag-in-box configuration. As seen in FIG. 2, the reservoir 201 may be provided within a reservoir container 204, which in some examples may be a box for protecting the reservoir 201 and/or maintaining the proper orientation of the reservoir 201 in the reservoir container 204. The reservoir 201 may be provided with a male end of a hermetic coupling mechanism 202, such as a nipple, nozzle, push valve, or the like. In a preferred example, the hermetic coupling mechanism is configured to maintain a hermetic and aseptic seal when the male end of a hermetic coupling mechanism 202 is coupled to a female end of a hermetic coupling mechanism 203, which may be coupled to the first end of product conduit 102, as shown in FIG. 2. In some examples, the reservoir 201 may be positioned, generally, above the system, so that the freezable, comestible liquid mixture can be gravity-fed into the system. In other embodiments, pressure may be applied to the reservoir 201 to aid in expelling the freezable, comestible liquid from the reservoir 201.

A product pump 205 may be provided in-line with product conduit 102 in order to pump or draw out the freezable, comestible liquid mixture from the reservoir 201 into product conduit 102. The product pump 205 may be a conventional pump capable of pumping a liquid within a conduit, and in some examples may be a peristaltic pump, a carbon dioxide gas-driven pump, another compressed gas-driven pump, or the like. In a preferred embodiment, the product pump 205 may be a positive displacement pump. In addition to drawing the comestible liquid mixture from the reservoir 201, the product pump 205 may also ensure a positive pressure on the product conduit 102 from a first end to a second end thereof. This may help to ensure that contaminants are not introduced into the system.

With reference back to FIG. 1, a product check valve 108 may be provided in-line with the product conduit 102 for maintaining the direction of flow of the freezable, comestible liquid mixture within the product conduit 102. The product conduit 102 may be coupled to overrun control module 103 by a first solenoid 110 that may control the amount of freezable, comestible liquid mixture introduced into overrun control module 103. The product conduit 102 may extend through the overrun control module 103. The overrun control module 103 is provided with an overrun controller 114 communicatively coupled to a flow regulator 112 and compressed gas regulator 113.

In addition to a product conduit 102, a gas conduit 107 may be coupled to the overrun control module 103. In some examples, the gas conduit 107 may extend through the overrun control module 103 and couple with the product conduit 102 at an intermediate portion (e.g., between the first and second ends of the product conduit 102). Alternatively, the gas conduit 107 may extend through the overrun control module 103 to the accumulator 105. The overrun control module 103 may be provided with a compressed gas regulator 113, which may be communicatively coupled to the overrun controller 114. A second solenoid 111 may be provided for coupling the gas conduit 107 with the overrun control module 103 and may be capable of controlling the amount of gas introduced into the overrun control module 103 from the compressed gas input 106.

Overrun control module 103 may mechanically or electronically operate one or more sets of pinches or valves (e.g., one for each of liquid product and gas), which may regulate the amounts freezable, comestible liquid mixture and gas to be passed to accumulator 105. In an embodiment, overrun control module 103 (which may include a programmable processor, e.g., overrun controller 114) may be electronically coupled to first solenoid 110 and second solenoid 111 and may send electrical signals to open and close first solenoid 110 and second solenoid 111 to send the appropriate amounts of freezable, comestible liquid product and compressed gas to the accumulator 105. The amounts (e.g., ratios or proportions) of freezable, comestible liquid product and compressed gas may be adjusted depending on the target product characteristics, operator preference, and the like. Overrun control module 103 may electronically operate first solenoid 110 and second solenoid 111 to open synchronously or asynchronously. In an embodiment, overrun control module 103 may open first solenoid 110 to allow a desired amount of freezable, comestible liquid product mixture to pass to the accumulator 105, close first solenoid 110, open second solenoid 111 to allow a desired amount of compressed gas (e.g., carbon dioxide, nitrogen, and the like) to pass through to accumulator 105. Accumulator 105 may mix the freezable, comestible liquid mixture and the compressed gas until a desired amount of gas becomes entrained in the liquid mixture. In an embodiment, overrun control module 103 may overpressurize accumulator 105 with an excess of compressed gas to ensure the desired amount of gas becomes entrained (e.g., dissolved or suspended) within the liquid mixture. Alternatively, or in addition, the cooling apparatus may chill accumulator 105 to reduce the excess gas and pressure required to entrain the desired amount of gas in the liquid mixture.

In an embodiment, overrun control module 103 may allow compressed gas and the freezable, comestible liquid product to independently pass directly into freeze chamber 108, where gas entrainment may occur during the chilling or freezing process.

FIG. 3 provides a representation of an example compressed gas input. A compressed gas input 106 may comprise a compressed gas canister 300. The compressed gas canister 300 may contain any compressed, sanitary gas appropriate for use in comestible food products. In a preferred example, the compressed gas is aseptic, and in some examples may be carbon dioxide, nitrogen, dehumidified air, or the like. The compressed gas may include a mixture of the aforementioned gases. The compressed gas may include helium. In an exemplary embodiment, the gas in the compressed gas canister 300 may be over 95% carbon dioxide. In an alternate embodiment, the gas in the compressed gas canister 300 may be over 95% nitrogen. The gas may be varied depending on operator preferences, such as taste of the end product, novelty characteristics (e.g., for imparting a high pitched voice in the case of helium), and the like.

The compressed gas canister 300 may be provided with an outlet 301 coupled to a pressure gauge 302. The pressure gauge 302 may provide a user with an indication of the amount of compressed gas remaining in the compressed gas canister 300. A gas conduit 107 may be coupled to an outlet of the pressure gauge 302 on a first end and coupled through the overrun control module 103 to accumulator 105 at a second end thereof. In particular, the gas conduit 107 may be coupled to the second solenoid 111 of the overrun control module 103, as discussed above. A check valve 109 may be provided in-line with the gas conduit 107 for maintaining the direction of flow of compressed gas within the gas conduit 107.

Referring back to FIG. 1, as discussed above, second solenoid 111 may control the amount of compressed gas introduced into the overrun control module 103. The overrun control module controller 114 may be electrically coupled to the product flow regulator 112 and the compressed gas regulator 113 to control the amount of compressed gas from the gas conduit 107 being mixed with the freezable, comestible liquid mixture. A user may program or otherwise introduce desired settings, such as liquid product to compressed gas ratios, gas pressures, and the like to control characteristics of the end product such as overrun. Where a second end of a product conduit 120 and a second end of a gas conduit 107 couples to accumulator 105, mixing of the gas and the freezable, comestible liquid may take place in accumulator 105. In alternate embodiments, a second end of a gas conduit 107 may couple in-line to a product conduit 102 at some point after the first solenoid 110 and before the accumulator 105; in such an embodiment, another check valve may be included at a second end of a gas conduit 107 to ensure one-way flow of gas into the product conduit 102. The ratio of gas to liquid may be controlled by the overrun control module 103 and may be adjusted to suit particular needs and preferences. In alternate embodiments, the ratio of gas to liquid may be controlled by first opening the first solenoid 110 until a particular amount of liquid passes through the first solenoid 110, then opening the second solenoid 111 to allow sufficient gas to produce the desired overrun level in the product. In some examples, the overrun control module 103 may be configured to produce an overrun between 20% and 80%. In other examples, the overrun control module 103 may be configured to produce an overrun between about 40% and 60%. In still more examples, the overrun control module 103 may be configured to produce an overrun at about 50%.

As discussed above, the overrun control module 103, and the apparatus 100 for producing a frozen, comestible product having an entrained gas as a whole, may or may not be provided with a water input 104. Accordingly, if no water is introduced into the comestible liquid mixture, the degrees Brix of the comestible liquid mixture within the reservoir may be substantially the same as the degrees Brix of the frozen comestible product when dispensed. In other embodiments, the comestible liquid mixture may be provided in a concentrated form. In some embodiments, the comestible mixture may be provided in a powder or liquid form. In these cases, the comestible mixture may be combined with a volume of water to produce the comestible liquid mixture that is later entrained with a gas. In many embodiments, the comestible liquid mixture may only be diluted with water by less than or equal to 2.5 parts water to 1 part comestible liquid mixture. Accordingly, the comestible liquid mixture may have a high viscosity, such that, when frozen, the product substantially retains its shape (rather than, for example, taking the shape of its container as is the case with conventional frozen carbonated beverages).

In an embodiment, the comestible liquid mixture may be packaged in bag-in-box form and may be ready to use (e.g., no dilution required). In an alternate embodiment, the comestible liquid mixture may be packaged in bag-in-box form but may require slight dilution may be required. Ranges of required dilution may vary between 0-2.5 parts of water to each part of comestible liquid mixture, depending on factors including viscosity and water content of the bag-in-box mixture, desired product characteristics, and the like. The comestible liquid mixtures may include mixtures used to create soft-serve products, such as ice cream, frozen yogurt, frozen custard, and the like. The comestible liquid mixtures may include dairy components, including milk and cream, or may contain lactose-free dairy substitutes, including soy milk, almond milk, cashew milk, coconut milk, or other lactose-free dairy substitutes. Compared to conventional frozen carbonated beverage syrup, the comestible liquid mixtures of the present disclosure may have higher Brix values (about 12° Bx to about 15° Bx post-dilution with water for conventional syrups versus about 20° Bx or more for mixtures of the present disclosure after any dilution, if required). In an embodiment, the comestible liquid mixtures of the present disclosure, after any required dilution, may have Brix values at about 35° Bx. In an embodiment, the comestible liquid mixtures of the present disclosure, after any required dilution, may have Brix values between about 25° Bx and about 30° Bx. The higher Brix values may reflect a higher concentration of dissolved sugars in the mixtures of the present disclosure, which may correlate with a higher viscosity. Generally, a higher Brix value of one liquid may correlate to a higher viscosity in that liquid.

From the overrun control module 103, the product conduit 102 and/or gas conduit 107 may be coupled to accumulator 105. The accumulator 105 may ensure that a gas is entrained with the freezable, comestible liquid heterogeneously by mixing or stirring the freezable, comestible liquid and the gas. The accumulator 105 may further be provided for ensuring an appropriate positive pressure for directing the freezable, comestible liquid mixture entrained with a gas to a freeze chamber 108. That is, an accumulator conduit 115 may couple accumulator 105 to the freeze chamber 108 and may be configured to introduce the freezable, comestible liquid mixture entrained with a gas into the freeze chamber 108. Accumulator 105 may be able to withstand certain pressures, for example, pressures above 25 PSI, pressures above 35 PSI, pressures above 45 PSI, and/or in some cases pressures between about 55 PSI to 120 PSI.

With continued reference to FIG. 1, the freeze chamber 108 may be provided with an agitator 116 driven by a motor 120 and may mix and stir the freezable, comestible liquid mixture entrained with a gas, a frozen product, and/or a combination thereof within the freeze chamber 108. The motor 120 and the agitator 116 may be selected to be capable of mixing and stirring a viscous freezable, comestible liquid mixture entrained with a gas. For example, the motor may be required to stir and agitate a mixture with a great viscosity, such as a frozen product whose viscosity is great enough that, when dispensed, the product substantially retains its shape.

Meanwhile, a cooling assembly, which may include a compressor 130 for compressing a refrigerant in the gas phase to the liquid phase, may be coupled to the freeze chamber 108 and configured to bring the temperature of the freeze chamber to below the freezing point of the freezable, comestible liquid mixture entrained with a gas to form a frozen entrained product. In some embodiments, the walls of the freeze chamber 108 are cooled, and the agitator 116 scrapes frozen product off the wall and re-mixes the frozen product with the freezable, comestible liquid mixture entrained with a gas. This process may be repeated through the freeze chamber 108 until, eventually, all the freezable, comestible liquid mixture entrained with a gas is frozen into frozen product. In a preferred embodiment, the cooling apparatus is capable of cooling the entrained comestible liquid mixture to 24 degrees Fahrenheit or less. Accordingly, the frozen entrained product, which in some examples is a soft serve ice cream or frozen yogurt product, is dispensed at a temperature of to 24 degrees Fahrenheit or less. In an alternate embodiment, the agitator 116 may also be cooled by the cooling assembly.

When the frozen, comestible product entrained with a gas is ready to be dispensed, a dispensing nozzle 116 may be actuated to dispense the desired amount of frozen, comestible product entrained with a gas.

Some differences between the frozen, comestible product entrained with a gas produced by apparatus and methods described herein and conventional frozen products will be described. For example, soft-serve ice cream or frozen yogurt may become entrained with a gas using the apparatus, systems, and methods disclosed therein. Conventional frozen, entrained products are more akin to slushes and related drinks. In essence, the frozen, comestible product envisioned by the present disclosure may have different physical properties than conventional products such as slushes. For example, the present disclosure envisions that soft-serve ice creams and frozen yogurts entrained with a gas may have significantly higher viscosities than conventional products, such that the dispensed product is capable of maintaining a shape formed during the dispensing process rather than taking the shape of the container. The frozen, comestible product envisioned herein is meant to be eaten (e.g., from a bowl with a spoon or a cone with the mouth and tongue) rather than drunk (e.g., through a straw) like a conventional product. The products envisioned herein may have higher Brix (20+° Bx compared to 12-15° Bx for conventional products), lower overrun (30-70% compared to 80-140% for conventional products), and lower serving temperature (24° F. or less compared to 25-29° F. for conventional products). The frozen, comestible products of the present disclosure may be produced with a lower air-to-base-mixture ratio, resulting in the lower overrun and contributing to the higher viscosity. The apparatus and systems disclosed herein, in order to handle the higher viscosity requirements of the freezable mixture and frozen comestible products compared to conventional products, may require larger motors, larger compressors, and heat evaporators and refrigerants that operate at lower temperatures.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. An apparatus for dispensing a comestible frozen product, the apparatus comprising:
a freezing chamber;
a product conduit having a first end and a second end,
wherein the first end of the product conduit is aseptically coupleable to a reservoir containing a freezable comestible mixture,
wherein the second end of the product conduit is aseptically coupleable to an accumulator, and
wherein the freezable comestible mixture has a Brix value greater than 15;
a gas conduit coupling a compressed gas source containing a compressed gas and one of the product conduit, an overrun control module, and the accumulator; and
a dispensing assembly coupled to the freezing chamber for dispensing a comestible frozen product;
wherein the overrun control module has a fluid connection with the product conduit and the gas conduit and adjustably regulates the quantities of freezable comestible mixture and compressed gas that flow to the accumulator to maintain a state of overpressurization;
wherein the compressed gas combines with the freezable comestible mixture to form an entrained liquid mixture, and wherein the freezing chamber receives the entrained liquid mixture to form the comestible frozen product.

2. The apparatus of claim 1, wherein the apparatus further comprises a pump that transfers the freezable comestible mixture from the reservoir to the product conduit.

3. The apparatus of claim 2, wherein the pump maintains a positive pressure on the product conduit.

4. The apparatus of claim 3, where the positive pressure is at least 20 pounds per square inch.

5. The apparatus of claim 1, wherein the Brix value of the freezable comestible mixture is greater than 18.

6. The apparatus of claim 1, wherein the reservoir connects to the first end of the product conduit by a hermetically sealable coupling.

7. The apparatus of claim 1, wherein the first end of the product conduit is aseptically, hermetically coupled to the reservoir.

8. The apparatus of claim 7, wherein the reservoir has a bag-in-box configuration.

9. The apparatus of claim 1, wherein the overrun control module maintains a ratio of the freezable comestible mixture and the compressed gas in the accumulator.

10. The apparatus of claim 1, wherein the compressed gas is an aseptic gas.

11. The apparatus of claim 10, wherein the gas is one of carbon dioxide, dehumidified air, nitrogen, helium, or a mixture thereof.

12. The apparatus of claim 1, wherein the overrun control module maintains an overrun percentage between 20% and 80% in the comestible frozen product.

13. The apparatus of claim 1, wherein the freezing chamber further includes a cooling assembly, wherein the cooling assembly chills the freezing chamber to less than 24 degrees Fahrenheit.

14. The apparatus of claim 1, wherein the freezable comestible mixture is diluted by water less than or equal to 2.5 parts water to 1 part freezable comestible mixture before reaching the overrun control module.

15. The apparatus of claim 1, wherein the freezable comestible mixture is not diluted before reaching the overrun control module.

16. The apparatus of claim 1, wherein the state of overpressurization prevents environmental air from infiltrating the apparatus.

17. A method of forming a comestible frozen product comprising:
aseptically introducing a freezable liquid mixture having a Brix value greater than 15 into a conduit, the conduit having a first end for receiving the freezable liquid mixture and a second end fluidly connected to a freezing chamber;
introducing an aseptic compressed gas into the conduit at an intermediate portion, the intermediate portion being between the first end and second end;
controlling a ratio of compressed gas and freezable liquid mixture within the conduit to form an entrained freezable liquid mixture and maintain a state of overpressurization;
introducing the entrained freezable liquid mixture into the freezing chamber; and
freezing the entrained freezable liquid mixture to form a comestible frozen product.

18. The method of claim 17, further comprising pumping a freezable liquid mixture from a reservoir containing the freezable liquid mixture into the conduit and maintaining a positive pressure on the conduit.

19. The method of claim 17, wherein the Brix value of the comestible frozen product is greater than 18.

20. An apparatus for dispensing a comestible frozen product, the apparatus comprising:
a reservoir containing a freezable comestible mixture having a Brix value greater than 15;
a freezing chamber;
an accumulator;
an overrun control module coupled to the accumulator;
a product conduit having a first end and a second end,
wherein the first end of the product conduit is aseptically and removably coupled to the reservoir, and
wherein the second end of the product conduit is coupled to the overrun control module;
a gas conduit coupling a compressed gas source containing a compressed gas to one of the product conduit, the overrun control module, and the accumulator; and
a dispensing assembly coupled to the freezing chamber for dispensing a comestible frozen product;
wherein the overrun control module has adjustable connections with the product conduit and the gas conduit and adjustably regulates the quantities of freezable comestible mixture and compressed gas that flow to the accumulator to maintain a state of overpressurization;
wherein the compressed gas combines with the freezable comestible mixture to form an entrained liquid mixture, and wherein the freezing chamber receives the entrained liquid mixture to form the comestible frozen product.
